(19) United States
(12) Patent Application Publication
(10) Pub. No.: US 2005/0206372 A1
(43) Pub. Date: Sep. 22, 2005

(54) Scale

(76) Inventor: Prakash Krishna Ratnaparkhi, Maharashtra (IN)

Correspondence Address: HEDMAN & COSTIGAN P.C., 1185 AVENUE OF THE AMERICAS, NEW YORK, NY, 10036, US

(21) Appl. No.: 11/044,903

(22) Filed: Jan. 27, 2005

(30) Foreign Application Priority Data
Jan. 28, 2004 (IN) 87/MUM/2004

(51) Int. Cl. G01B 7/14

(52) U.S. Cl. 324/207.24

(57) ABSTRACT

A scale comprising an elongated extruded body with end caps, an elongated linear magnetic scale magnetized with alternate south and north poles along its length and fitted in said extruded body, a reader head, comprising of magneto-resistive sensors with electronic signal processing circuitry, slidably mounted and guided in said extruded body in a substantially fixed distance apart relationship with said magnetic scale and said reader head having signal terminals for power supply and displacement signals; wherein said signal terminals of said movable reader head are extended to one of the fixed ends of said extruded body by means of a flexible multi-conductor cable arranged inside said extruded body.

### FIELD OF THE INVENTION

The present invention relates to scales and linear transducers for measuring displacement.

### PRIOR ART

Linear scales based on optical, inductive, magnetic or capacitive principle are known for a long time. FIG. 1 of the accompanying drawings illustrates schematically a linear scale according to the prior art. Typically, these linear scales comprise an elongated graduated scale strip (3) mounted in an aluminum extruded body (1) and a reader head (2) disposed in front of the scale strip (3) inside the aluminum extruded body (1) and slidable along the length of the scale strip (3). A part of the reader head unit (2), carrying electronic signal processing circuitry, extends outside the extruded body from a slit in the extruded body along its length and this slit is covered by rubber lips for environmental protection. Usually the elongated extruded body (1) is mounted on the fixed part of a machine and the reader head (2) is mounted on the moving part of the machine.

These linear scales have two major drawbacks.
1. It is very difficult to mount and align these scales on a machine as it requires critical alignment of the extruded body (1) and the reader head (2) with reference to the direction of the motion and also with reference to each other to maintain a critical gap (41) (of the order of 0.1 mm or less) between the reader head (2) and the scale strip (3) for its reliable operation. Also the need of critical gap(41) in these scales make them sensitive to temperature variations, shocks and vibrations, thus resulting in unreliable displacement measurements under harsh environments.
2. The power supply and displacement signals of the electronic signal processing circuitry on the reader head (2) are extended to a counter unit (40) located on some other side of the machine by means of extension cable (32). As the slider unit is moving with the moving part of the machine, it is necessary to keep excess length of the extension cable (32). This makes it very cumbersome particularly for longer machine strokes when loop of this extension cable (32) comes in the way of other machine parts and mechanisms during the machine movement, thus, resulting in accidents due to pulling or damage or breakage of the extension cable (32). If to avoid this problem, the scale-extruded body (1) is mounted on the moving part and the Reader head (2) is fixed on the stationary machine part, such arrangement endures measurement errors and thus is not recommended due to alignment difficulties in mounting long scales traveling longer distances.

A Linear Transducer, commonly known as LT, is also a linear measuring device used to measure displacement between two parts—one stationary and another one moving; e.g. it is commonly used in injection moulding machines to measure the displacement of the moving platen with reference to the stationary platen. For similar purposes, LT is also used in many other machines and mechanisms like—press, shearing, metal cutting machines etc.

FIG. 2 of the accompanying drawings illustrates schematically the principle of operation of a linear transducer according to the prior art. Presently, all these LTs are based on linear potentiometer principle wherein, a strip of insulating material (51) is uniformly coated with a resistive material (52) and an electrical wiper or brush (50) is made to slide on it. This assembly is mounted in an elongated aluminum extruded body with end covers (not shown) for environmental protection. The brush (50) is connected to a moving arm (not shown) extending from one end cover of the extruded body and the three electrical terminals of this potentiometer are extended to a connector (not shown) mounted near the other end of the extruded body. Usually, the extruded body is mounted on the fixed part of the machine whereas the moving arm is fixed to the moving part of the machine. A dc input voltage (53) is applied between the extreme end terminals of the resistive strip and the output voltage signal (54) measured between the brush terminal and one of the end terminals of the resistive strip is proportional to the displacement of the moving part with reference to the fixed part of the machine.

Although, in this arrangement, the mounting of the LT on a machine is easy and also the electrical connections of the potentiometric sensor are available from the fixed extruded body of the LT and thus they do not entangle with the moving machine elements, these potentiometric sensors are coarse and they cannot provide fine resolution of measurement particularly when the length of the potentiometric sensor is relatively longer. Also, due to the mechanical contact between the brush and the resistive strip, both are prone to wear and tear and failure. Moreover, entry of water, coolant or oil inside the extruded body can damage the potentiometric sensor or make the displacement measurement unreliable.

U.S. Pat. Nos. 5,570,015 & 6,825,656 & U.S. patent application Nos. 20040036467 & 20040129095 describe linear transducers based on the magnetic principle wherein the magnetic sensor is mounted on the fixed part of the transducer and the magnetic body is mounted on the moving part of the transducer. In these transducers, though the power supply & signal carrying cables extend from the fixed magnetic sensor part of the transducer, these transducers are limited in their length of stroke & the displacement resolution.

### SUMMARY OF THE INVENTION

In order to realize a reliable and flexible measuring scale, this invention uses magnetic measuring technology, as well as, unique novel engineering techniques explained below to achieve environmental protection from vibrations, shocks, dust and the like and still give higher precision at high speed with repeated consistency and long life with ease of mounting for the end user. The scale according to this invention primarily overcomes the problems encountered because of the extension cable connected to the reader head and the requirement necessity of the critical alignment of the reader head unit and scale unit while mounting on machine body. Several more benefits arise due to the novel construction of the scale.

### BRIEF DESCRIPTION OF THE ACCOMPANYING DRAWINGS

FIG. 1 illustrates schematically a linear scale according to the prior art;

FIG. 2 illustrates schematically the principle of operation of a linear transducer according to the prior art;

FIG. 3 illustrates schematically a partial sectional view of the scale according to the first embodiment of the present invention;

FIG. 4 illustrates schematically a cross sectional view in plane A-A marked in FIG. 3 according to the present invention;

FIG. 5 illustrates schematically a detailed view of the reader head of the scale of FIG. 3;

FIGS. 6A illustrate schematically an alternate mounting arrangement of the scale of FIG. 3;

FIG. 6B is the view of the embodiment in FIG. 6A seen form the direction arrow in FIG. 6A;

FIGS. 7 illustrate schematically another alternate mounting arrangement of the scale of FIG. 3;

FIG. 8 illustrates an embodiment of the present invention for a non-linear application;

FIG. 9 illustrates alternate guiding means of the reader head (2) of the scale of FIG. 3;

FIG. 10 illustrates schematically the inside view of the scale according to another embodiment of the present invention;

FIG. 11A illustrates schematically the inside view of the scale according to yet another embodiment of the present invention; and

FIG. 11B illustrates schematically the reader head and rack and pinion arrangement at location C in FIG. 11A.

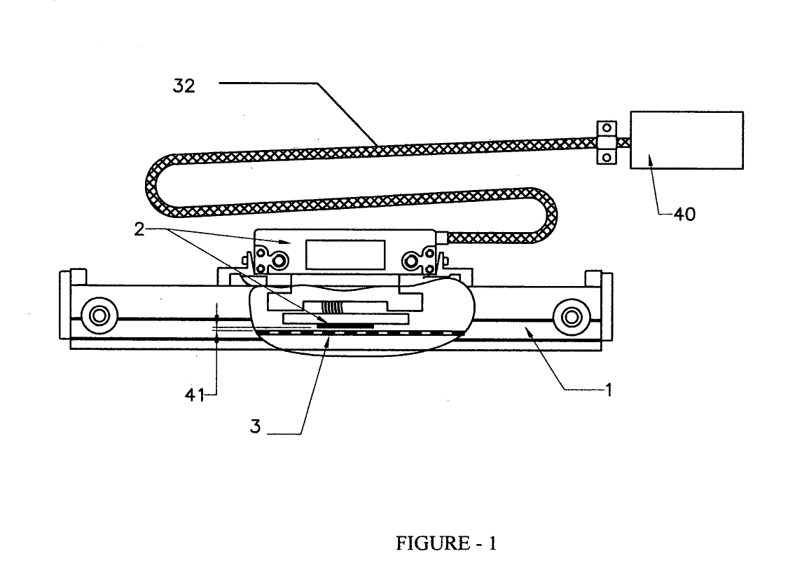

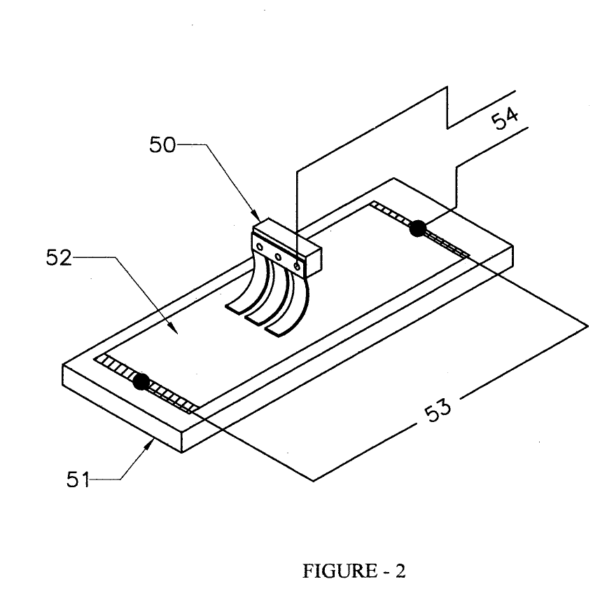

### DETAILED DESCRIPTION OF THE PREFERRED EMBODIMENTS

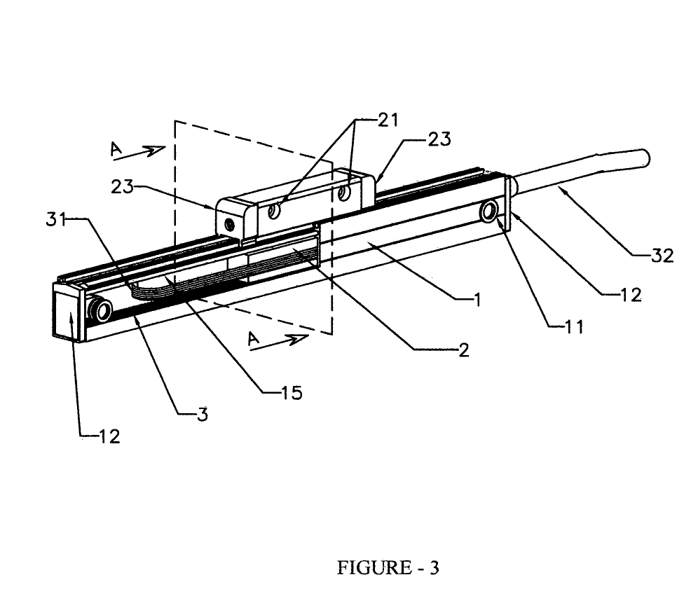

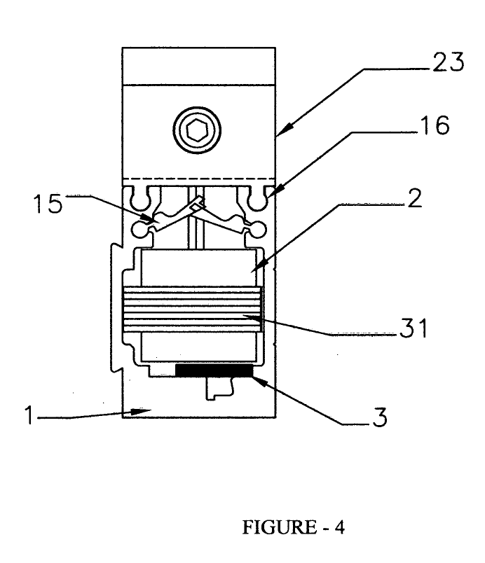

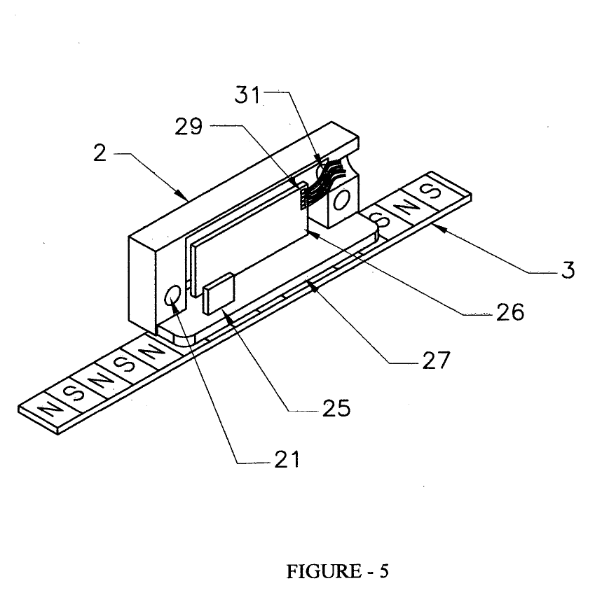

The invention will now be described with reference to FIGS. 3 to 11 of the accompanying drawings. The scale comprises of
an elongated extruded body (1) with end caps (12) usually in aluminum as an enclosure of the scale for protection,
an elongated magnetic scale (3) magnetized with alternate south (S) and north (N) poles along its length and fitted in said extruded body (1),
a hermetically sealed reader head (2), comprising of magneto-resistive sensors (25) (like AMR or GMR or Hall Effect sensor) with electronic signal processing circuitry (26), slidably mounted and guided in said extruded body (1) in a substantially fixed distance apart relationship with said magnetic scale (3) and
said reader head (2) having signal terminals for power supply and displacement signals.

The reader head (2) can be either in plastic enclosure or in metallic enclosure and can have a shape to suit the cross section design of the extruded body. Further for reliable operations, such reader head (2) is potted with suitable epoxy compound to give it protection from shocks and vibrations as well as to provide it with high level of climatic protection like IP67 standard. For easy and self-guided movement of the reader head (2), the reader head (2) is provided with low wear and low friction plastic bearing guide blocks (23) made to suit the internal profile acting as guide ways (16) of the extruded body (1). These bearing guide blocks (23) are fitted on either side of the reader head (2), screwed with the help of screws which can be removed or may be kept in place after the installation is complete.

In case of an extruded body (1), the guiding blocks (23) are made from similar material as mentioned above and have the shape to suit the internal profiles of this extruded body. However, they are glued with suitable glue, which will help them remain permanently glued to either side of the reader head (2). When glued at a proper location, they guide the reader head (2) unit within the extruded body (1) throughout the length with high accuracy, acquiring low friction during its movement. This ensures proper alignment of the reader head (2) with reference to the magnetic scale (3). The extreme end positions in the travel of said reader head (2) are arrested by means of stoppers (13) on one or both the sides.

The signal terminals of said movable reader head (2) are extended to one of the fixed ends of the extruded body (1) by means of a flexible multi-conductor cable (31) arranged inside the extruded body (1). The flexible multi-conductor cable (31) is either soldered or connected through a connector to the reader head (2) signal terminals. In one of the embodiments, a connector (17) is mounted near one of the fixed ends of said extruded body (1) and one end of said flexible multi-conductor cable (31) is connected to the terminals of said connector (17) directly or through an adaptor PCB.

Typically, the flexible multi-conductor cable (31) is in the form of a flexible printed circuit board. The flexible multi-conductor cable (31) is arranged in a special recessed space provided inside said extruded body (1) in such a way that during winding and unwinding process, the cable (31) is always guided in the slot provided in the extruded body (1). The flexible multi-conductor cable (31) is preferably partly fixed inside said extruded body (1) by means of clamps or glue.

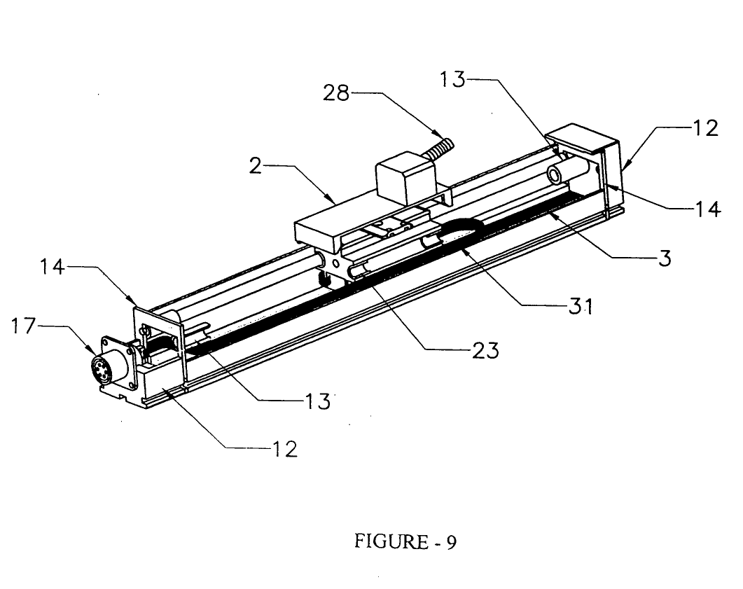

The reader head (2) with the help of guiding blocks (23) is slidably mounted and guided on guide ways (16) formed by grooves in said extruded body (1), and provided with bearing material such as Teflon, Turcite or modified polymer etc. Alternatively, the reader head (2) is slidably mounted and guided by means of external bearing elements or linear motion guides or ball bearing attached to said extruded body (1) and made of bearing material such as Teflon, Turcite etc. In yet another embodiment of the invention of the reader head (2) guiding bearing elements (23) are removable after installation of the scale on a machine. FIG. 9 illustrates alternate method of guiding of the reader head (2) using rods as guide ways (16) and bush bearings as guides (23).

The magnetic scale (3) is in the form of a tape or rod or wire which is made up of magnetic material or coated with magnetic material. The magnetic scale tape is usually directly glued on the bottom face or side face of the inside of the extruded body. Another way of mounting the magnetic scale tape is either by gluing it separately on a metal strip which can be glued or clamped mechanically inside the extruded body (1). The magnetic scale (3) is magnetized with alternate S and N poles at a fixed pole pitch e.g. 0.5 mm or 1 mm or 2 mm or 5 mm etc. The magneto-resistive sensor (25) is placed facing the magnetic scale (3) at a gap of 10% to 80% of the pole pitch which is less critical as compared to that in case of the scales based on optical principle.

As the reader head (2) moves across the magnetic scale (3), the magneto-resistive sensors (25) senses the variations in the magnetic field and generate analogue displacement signals which are further processed by the electronic signal processing circuitry (26) mounted in said reader head (2). The electronic signal processing circuitry (26) consists of signal conditioners and/or signal interpolator and/or counter. The signal interpolator of the electronic signal processing circuitry is capable of dividing the each cycle of analogue displacement signals corresponding to one pole pitch of the magnetic scale by a factor 5 to 8000, depending on pre-setting, in order to provide very fine displacement resolution. The output displacement signals of the electronic signal processing circuitry (26) brought on the terminals of said reader head (2) are in the form of incremental pulses or absolute position or analogue signal in the form of 0-10 Volts or 4-20 mA. In another embodiment of the present invention, the electronic signal processing circuitry (26) is provided with a battery backed up power for retention of the absolute position information, in case of main power failure.

In the first embodiment of the present invention, the extruded body (1) has a C-shape and a part of said reader head (2) extends out side of the said extruded body (1) through the open side of said C-shape. The open side of said C-shaped extruded body (1) is sealed for protection by means of rubber lips (15) inserted in the grooves provided in said extruded body (1). In another embodiment of the invention, the open side of said C-shaped extruded body (1) is sealed for protection by means of a fixed metal strip inserted through a central slit of said reader head (2) and covering the open side of said C-shaped extruded body (1).

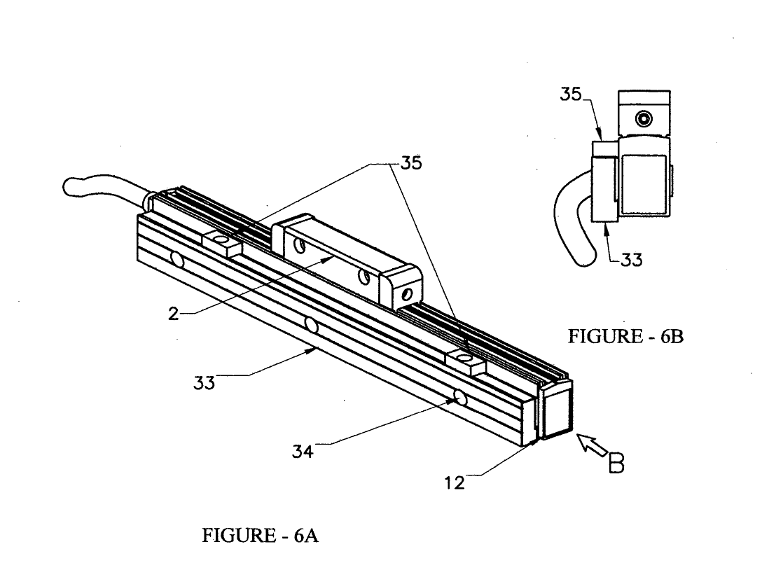

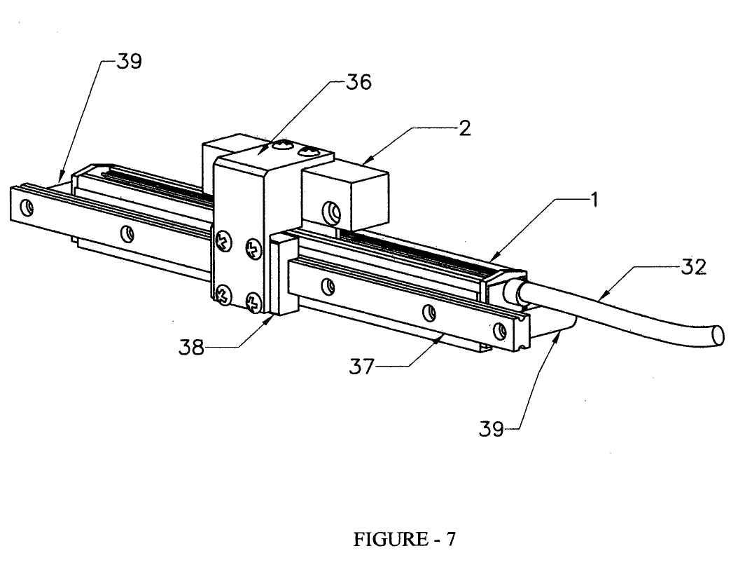

FIGS. 3, 6, 7 and 9 of the accompanying drawings illustrate schematically the various alternatives of the mounting arrangements of the scale according to the invention wherein FIG. 3 shows the extruded body (1) provided with mounting holes (1 1). FIG. 6 shows the extruded body (1) provided with clamps (35) for mounting on dovetail (33) which is mounted on the machine body through mounting holes (34). FIG. 7 shows an arrangement wherein the extruded body (1) is mounted on LM guide (37) which is mounted on machine body using spacer blocks (39). The reader head (2) is mounted on the carriage guide shoe (38) using the connecting block (36) for well-aligned displacement of the reader head (2). FIG. 9 shows external grooves (18) on the extruded body (1) for mounting by clamps.

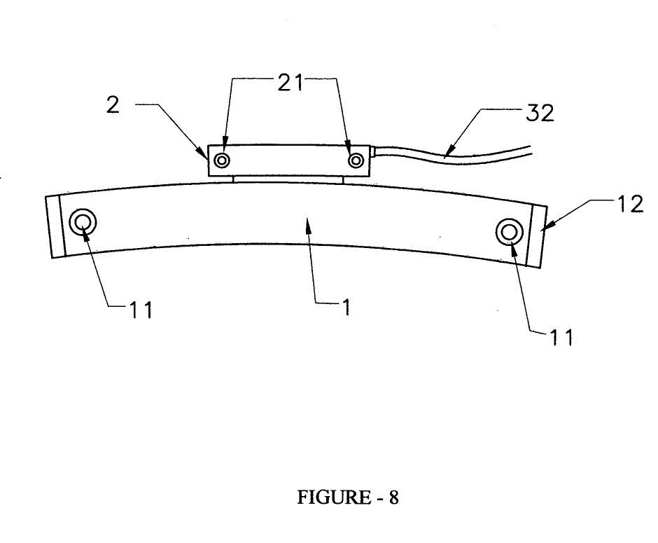

FIG. 8 of the accompanying drawings illustrates a non-linear scale according to the present invention wherein the displacement of the reader head (2) is non-linear according to the curvilinear shape of the extruded body (1). This scale is useful when the movement of the machine part in non-linear.

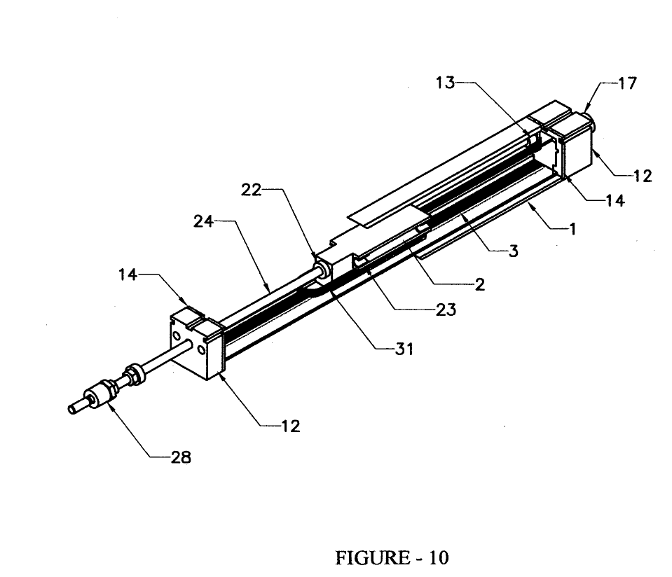

FIG. 10 of the accompanying drawings illustrates schematically the inside view of the scale according to the second embodiments of the present invention wherein said reader head (2) is completely enclosed inside said extruded body (1) and is movable by means of a shaft or arm (24) flexibly connected by means of a ball joint (22) to said reader head (2) and extending outside said extruded body (1) through one of its end caps (12). The extruded body (1) is sealed against dust and liquid entry from all sides using end caps (12) mounted through gaskets (14) and sealing the opening of one of the end caps (12) from where said mounting arm (24) extends outside said extruded body (1). The mounting arm (24) gives extreme ease of installation of the guided scale. The mounting arm (24) is also provided with a universal coupling (28) at the end, which is connected to the moving element of the machine on which the scale is installed.

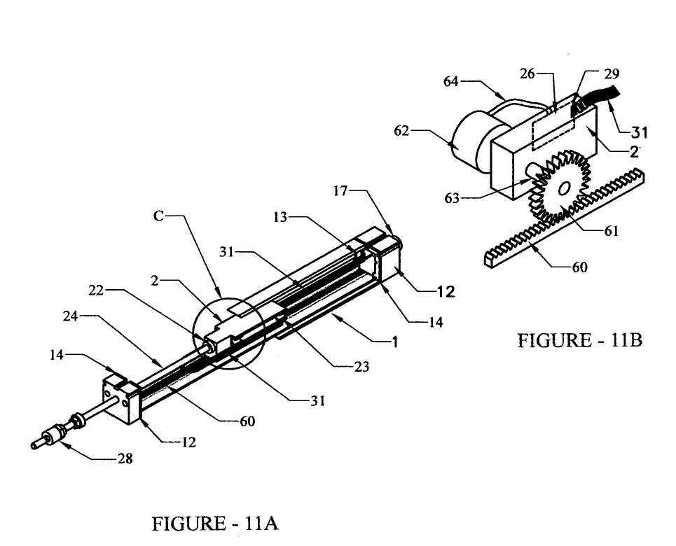

FIG. 11A of the accompanying drawing illustrates schematically the inside view of the scale according to a third embodiment of the present invention. FIG. 11B of the accompanying drawing illustrates schematically the reader head and rack and pinion arrangement at location C of the scale according to a third embodiment of the present invention wherein said reader head (2) comprises a magnetic rotary encoder (62) mounted on the body of the reader head (2). A pinion (61) is mounted on the shaft (63) of the magnetic rotary encoder (62). An elongated rack (60) is mounted inside the extruded body (1) and the gear teeth of the pinion (61) are engage with the gear teeth of the elongated rack (60) in a rack and pinion type gear arrangement. With this arrangement, the longitudinal displacement of the reader head (2), which is slidably mounted and guided in said extruded body (1), is converted into the rotary movement of encoder shaft (63). The magnetic rotary encoder (62) is a conventional encoder of the prior art comprises of a rotary magnetic disc mounted on the encoder shaft (63) and magnetized with alternate sectors of South and North poles. Magneto-resistive sensors are mounted inside the housing of the magnetic rotary encoder (62) in a fixed apart distance relationship with said rotary magnetic disc. The magneto-resistive sensors sense the variation in the magnetic field, as the encoder shaft (63) rotates and generates analogue displacement signals which are carried through encoder cable (64) to the electronic processing circuit (26). The electronic signal processing circuitry (26) consists of signal conditioners and/or signal interpolator and/or counter. The electronic signal processing circuitry (26) also scales the displacement signals according to the gear ratio of the rack and pinion gear arrangement and produces the output displacement signals on the terminals (29) of said reader head (2). The signals on terminals (29) are extended to the connector (17) mounted on one end of said extruded body (1) by manes of flexible multi-conductor cable (3 1) arranged inside said extruded body (1).

Thus, the scales according to the invention and as disclosed through the forgoing description overcome several drawbacks of the prior art in the following manner.
As the reader head (2) is firmly guided on the extruded body (1) of the scale and is connected to the moving part of the machine with the help of an arm (24) and flexible coupling free of any play, it is very easy to install this scale on a machine. The critical alignment of the reader head (2) on the machine to maintain a specific gap (41) of the reader head (2) with the scale unit is not necessary as it is already taken care of in the extruded body (1). Also due to the magnetic scale technology, the gap (41) is less critical and it can be few tenths of mm depending on the pole pitch of the magnetic scale. As a result, it is less prone to temperature variations, shocks and vibrations.
As the extension cable (32) is derived from the stationary connector (17) on the extruded body (1) of the scale which is mounted on fixed part of the machine unit, the extension cable (32) can be routed properly on the body of the machine without any danger of entangling it with the moving parts of the machine and getting damaged.
As the scale is based on non-contact magnetic position detection principle, it is more robust and reliable even in dusty and misty atmosphere.

While considerable emphasis has been placed herein on the structures and structural interrelationships between the component parts of the preferred embodiments, it will be appreciated that many embodiments can be made and that many changes can be made in the preferred embodiments without departing from the principles of the invention. These and other changes in the preferred embodiment as well as other embodiments of the invention will be apparent to those skilled in the art from the disclosure herein, whereby it is to be distinctly understood that the forgoing descriptive matter is to be interpreted merely as illustrative of the invention and not as a limitation.

1. A scale comprising
an elongated extruded body with end caps,
an elongated linear magnetic scale magnetized with alternative south and north poles along its length and fitted in said extruded body,
a reader head, comprising of magneto-resistive sensors with electronic signal processing circuitry, slidably mounted and guided in said extruded body in a substantially fixed distance apart relationship with said magnetic scale and
said reader head having signal terminals for power supply and displacement signals;
wherein said signal terminals of said movable reader head are extended to one of the fixed ends of said extruded body by means of a flexible multi-conductor cable arranged inside said extruded body.

2. A scale as claimed in claim 1, wherein a connector is mounted near one of the fixed ends of said extruded body and one end of said flexible multi-conductor cable is connected to the terminals of said connector.

3. A scale as claimed in claim 1, wherein said flexible multi-conductor cable is soldered and/or connected through a connector to said reader head signal terminals.

4. A scale as claimed in claim 1, wherein said flexible multi-conductor cable is in the form of a flexible printed circuit board.

5. A scale as claimed in claim 1, wherein said flexible multi-conductor cable is arranged in a special recessed space provided inside said extruded body.

6. A scale as claimed in claim 1, wherein said flexible multi-conductor cable is partly fixed inside said extruded body by means of clamps or glue.

7. A scale as claimed in claim 1, wherein said reader head is slidably mounted and guided in the grooves formed in said extruded body by means of bearing material such as Teflon or Turcite or modified polymer.

8. A scale as claimed in claim 1 wherein said reader head is slidably mounted and guided by means of external bearing elements attached to said extruded body of bearing material such as Teflon or Turcite or modified polymer or linear motion guides or ball bearing.

9. A scale as claimed in claim 1, wherein said reader head guiding bearing elements are removable.

10. A scale as claimed in claim 1, wherein the extreme end positions in the travel of said reader head are arrested by means of stoppers on one or both the sides.

11. A scale as claimed in claim 1, wherein said magnetic scale in the form of a tape or rod or wire is made up of magnetic material or coated with magnetic material.

12. A scale as claimed in claim 1, wherein said electronic signal processing circuitry mounted in said reader head consists of signal conditioners and/or signal interpolator and/or counter.

13. A scale as claimed in claim 1, wherein said displacement signals on said terminals of said reader head are in the form of incremental pulses.

14. A scale as claimed in claim 1, wherein said displacement signals on said terminals of said reader head are in the form of absolute position or analogue signal in the form of 0-10 Volts or 4-20 mA.

15. A scale as claimed in claim 1, wherein said electronic signal processing circuitry incorporates battery backed up power.

16. A scale as claimed in claim 1, wherein said extruded body is provided with mounting holes or external grooves or dovetail arrangement.

17. A scale as claimed in claim 1, wherein said extruded body has a C-shape and a part of said reader head extends out side the said extruded body through the open side of said C-shape.

18. A scale as claimed in claim 17, wherein said open side of said C-shaped extruded body is sealed for protection by means of rubber lips inserted in the grooves provided in said extruded body and said open side of said C-shaped extruded body is sealed for protection by means of a fixed metal strip inserted through a central slit of said reader head and covering the open side of said C-shaped extruded body.

19. A scale as claimed in claim 1, wherein said reader head is completely enclosed inside said extruded body and is movable by means of a rod flexibly connected to said reader head and extending outside said extruded body through one of its end caps.

20. A scale as claimed in claim 1, wherein said extruded body is sealed from all sides, against dust and liquid entry, including said end cap from where said rod extends outside said extruded body.
